(19) United States
(12) Patent Application Publication
(10) Pub. No.: US 2021/0297685 A1
(43) Pub. Date: Sep. 23, 2021

(54) COEFFICIENT CODING OF TRANSFORM SKIP BLOCKS IN VIDEO CODING

(71) Applicant: QUALCOMM Incorporated, San Diego, CA (US)

(72) Inventors: Marta Karczewicz, San Diego, CA (US); Alican Nalci, La Jolla, CA (US); Muhammed Zeyd Coban, Carlsbad, CA (US); Vadim Seregin, San Diego, CA (US)

(73) Assignee: QUALCOMM Incorporated, San Diego, CA (US)

(21) Appl. No.: 17/205,883

(22) Filed: Mar. 18, 2021

Related U.S. Application Data
(60) Provisional application No. 62/992,570, filed on Mar. 20, 2020.

(51) Int. Cl. H04N 19/44; H04N 19/105; H04N 19/189; H04N 19/176

(52) U.S. Cl. CPC H04N 19/44; H04N 19/176; H04N 19/189; H04N 19/105

(57) ABSTRACT

An example method of decoding video data includes determining that one or more lossy coding tools are enabled at a picture level or slice level for a picture or slice of video data that includes a current block, determining that the current block is decoded with transform skip, bypassing use of the one or more lossy coding tools for the current block based on the determination that the current block is decoded with transform skip, performing a residual coding scheme to generate a residual block, and reconstructing the current block based on the residual block.

This application claims the benefit of U.S. Provisional Patent Application No. 62/992,570, filed 20 Mar. 2020, the entire contents of which is incorporated herein by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for coding for transform skip blocks. For example, the disclosure describes examples of restrictions imposed for transform skip blocks with regard to sign data hiding (SDH) and dependent quantization (DQ) when regular coefficient coding is used. In video coding, a residual block represents a difference between a current block and a prediction block. In some examples, a residual block is transformed (e.g., using a discrete cosine transform (DCT) or discrete sine transform (DST)). However, in some examples, the transform operation may be skipped, and such residual blocks are referred to as transform skip blocks.

In some examples, a video encoder and a video decoder may utilize lossy coding tools, such as DQ or sign data hiding (SDH), for encoding or decoding blocks in a picture or slice. For instance, a picture header or slice header may indicate that DQ and/or SDH is enabled for the picture or slice. In some cases, transform skip blocks are to be lossless coded. Accordingly, if there are to be any transform skip blocks in the picture or slice, then DQ or SDH may need to be disabled. This disclosure describes example ways to selectively bypass lossy coding tools (e.g., DQ and SDH), even if enabled at a picture or slice level, for transform skip blocks in the picture or slice. The example techniques allow for achieving the benefits associated with lossy coding (e.g., reduction in bits) for some blocks in the picture or slice, while also allowing for some blocks in a picture or slice to be losslessly coded (e.g., to reduce distortion and preserve video quality). In this way, the example techniques may provide for practical applications to video coding techniques that may improve the operation of a video coder (e.g., video encoder and/or video decoder).

In one example, this disclosure describes a method of decoding video data includes determining that one or more lossy coding tools are enabled at a picture level or slice level for a picture or slice of video data that includes a current block, determining that the current block is decoded with transform skip, bypassing use of the one or more lossy coding tools for the current block based on the determination that the current block is decoded with transform skip, performing a residual coding scheme to generate a residual block, and reconstructing the current block based on the residual block.

In another example, this disclosure describes a device for decoding video data includes memory configured to store the video data, and processing circuitry coupled to the memory and configured to determine that one or more lossy coding tools are enabled at a picture level or slice level for a picture or slice of the video data that includes a current block, determine that the current block is decoded with transform skip, bypass use of the one or more lossy coding tools for the current block based on the determination that the current block is decoded with transform skip, perform a residual coding scheme to generate a residual block, and reconstruct the current block based on the residual block.

In another example, this disclosure describes a device for decoding video data includes means for determining that one or more lossy coding tools are enabled at a picture level or slice level for a picture or slice of video data that includes a current block, means for determining that the current block is decoded with transform skip, means for bypassing use of the one or more lossy coding tools for the current block based on the determination that the current block is decoded with transform skip, means for performing a residual coding scheme to generate a residual block, and means for reconstructing the current block based on the residual block.

In another example, this disclosure describes a computer-readable storage medium having stored thereon instructions that, when executed, cause one or more processors to determine that one or more lossy coding tools are enabled at a picture level or slice level for a picture or slice of video data that includes a current block, determine that the current block is decoded with transform skip, bypass use of the one or more lossy coding tools for the current block based on the determination that the current block is decoded with transform skip, perform a residual coding scheme to generate a residual block, and reconstruct the current block based on the residual block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example quadtree binary tree (QTBT) structure, and a corresponding coding tree unit (CTU).

FIG. 3 is a block diagram illustrating an example video encoder that may perform the techniques of this disclosure.

FIG. 4 is a block diagram illustrating an example video decoder that may perform the techniques of this disclosure.

FIG. 5 is a flowchart illustrating an example method of decoding video data.

### DETAILED DESCRIPTION

In video coding, a video encoder determines a prediction block, also called a predictive block, for a current block being encoded. The video encoder determines a residual block indicative of a difference between the current block and the prediction block. In some examples, the video encoder transforms the residual block using a discrete cosine transform (DCT) or a discrete sine transform (DST). The result is a transform block with coefficient values that may be quantized, encoded (e.g., entropy encoded), and then signaled.

However, in some examples, the transform operation may be skipped. In such examples, the residual block is referred to as a transform skip block, and the values of the transform skip block may be quantized, encoded, and then signaled. For transform skip blocks, the quantization operation may also be skipped in some examples.

A video decoder receives the signaled values in the bitstream and performs an inverse quantization operation, if needed. Next, if the video encoder performed the transform operation on a block, then the video decoder performs an inverse transform operation to generate a residual block. If, however, transform was skipped (e.g., for a transform skip block), then the video decoder may bypass the inverse transform operation and the transform skip block may be the same as the residual block. In both cases, the video decoder determines the prediction block using the same techniques as the video encoder (e.g., based on information signaled by the video encoder such as motion information or intra-prediction mode), and adds the residual block to the prediction block to reconstruct the current block.

Use of transform skip blocks may be desirable for lossless coding. For instance, with transform, some of the video data is lost. However, when transform is skipped, the video data is preserved. In some cases, a beneficial balance between bandwidth efficiency and video quality may be realized if there is a combination of lossy and lossless coding in a picture or slice (e.g., some blocks are lossy coded and some blocks are losslessly coded).

There may be certain coding tools that are applied at a picture or slice level that are lossy coding tools. Two examples of coding tools that apply at the picture or slice level that are lossy coding tools include dependent quantization (DQ) and sign data hiding (SDH). If such coding tools are applied to all blocks in the picture or slice, then lossless coding may not be available. However, disabling of such coding tools may not be desirable because, in some cases, a combination of lossless and lossy coding may be beneficial.

This disclosure describes example ways in which video coding tools, such as DQ and SDH, that are lossy and signaled at the picture or slice level are still signaled at the picture or slice level but are then disabled at a transform skip block level. This way, it may be possible to mix lossy and lossless coding (e.g., have some blocks that are lossless coded and some blocks that are lossy coded in the same picture or slice).

In some examples, DQ and SDH may be available for transform coefficient coding (TRCC), which is one example of a residual coding scheme. Accordingly, in some examples, DQ and SDH coding techniques may be disabled for transform skip blocks that are using TRCC. Transform skip blocks may also be referred to as transform skipped blocks, and transform skip block level may be referred to as transform skipped block level.

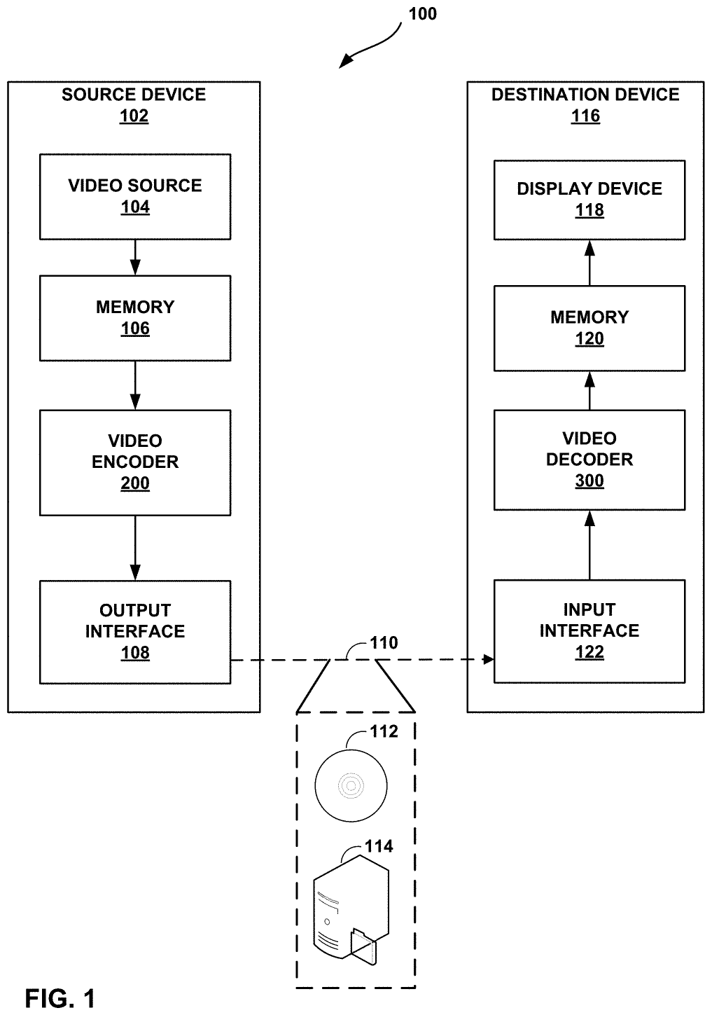

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for coding of transform skip blocks. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for coding of transform skip blocks. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may demodulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as the upcoming ITU-T H.266, also referred to as Versatile Video Coding (VVC). A recent draft of the VVC standard is described in Bross, et al. “Versatile Video Coding (Draft 8),” Joint Video Experts Team (WET) of ITU-T SG 16 WP 3 and ISO/IEC JTC 1/SC 29/WG 11, 17th Meeting: Brussels, BE, 7-17 Jan. 2020, JVET-Q2001-vE (hereinafter “VVC Draft 8”). The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile.

The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

In some examples, VVC may provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. In some examples, VVC may provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

However, in some examples, the transform operation may be skipped. In such examples, the residual block may be referred to as a transform skip block or a transform skipped block.

As noted above, following any transforms to produce transform coefficients or where transform is skipped, video encoder 200 may perform quantization of the transform coefficients or the values of the transform skip block. Quantization generally refers to a process in which transform coefficients or values of the transform skip block are quantized to possibly reduce the amount of data used to represent the transform coefficients or values of the transform skip block, providing further compression. By performing the quantization process, video encoder 200 may reduce the bit depth associated with some or all of the transform coefficients or values of the transform skip block. For example, video encoder 200 may round an n-bit value down to an m-bit value during quantization, where n is greater than m. In some examples, to perform quantization, video encoder 200 may perform a bitwise right-shift of the value to be quantized. In some examples, quantization may be bypassed such as for transform skip blocks.

Following quantization, video encoder 200 may scan the transform coefficients or values of the transform skip block (e.g., transform is not performed), producing a one-dimensional vector from the two-dimensional matrix including the quantized transform coefficients or quantized values of the transform skip block, if quantization is performed. The scan may be designed to place higher energy (and therefore lower frequency) transform coefficients at the front of the vector and to place lower energy (and therefore higher frequency) transform coefficients at the back of the vector. If transform is skipped, then there may not be a separation of higher energy and lower energy coefficients. In some examples, video encoder 200 may utilize a predefined scan order to scan the quantized transform coefficients or values of the transform skip block (quantized or not quantized) to produce a serialized vector, and then entropy encode the quantized transform coefficients or values of the transform skip block (quantized or not quantized) of the vector. In other examples, video encoder 200 may perform an adaptive scan. After scanning the quantized transform coefficients or the values of the transform skip block to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients or quantized values of a transform skip block. As noted above, quantization may be skipped in some examples. Video decoder 300 may inverse quantize and inverse transform the quantized transform coefficients of a block to reproduce a residual block for the block. For the transform skip block, video decoder 300 may inverse quantize (if needed) the transform skip block and the result is the residual block, and if inverse quantizing is not needed, then the result from the CABAC decoding may be the values for the residual block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

This disclosure describes example techniques related to coding of transform skip blocks using a regular transform coefficient coding scheme (e.g., residual_coding( ) defined in virtual test model (VTM)-8.0 specification for VVC Draft 8). That is, in some examples, for transform skip blocks, the residual coding scheme used by video encoder 200 and video decoder 300 may be the same as the residual coding scheme used by video encoder 200 and video decoder 300 for transform coefficients (e.g., when transform is performed on a block). The residual coding scheme used for transform coefficients when transform is performed is referred to as regular transform coefficient coding, or simply transform coefficient coding (TRCC). Another residual coding scheme is transform skip (TS) residual coding (TSRC). TSRC may be used for transform skip blocks.

As noted, TRCC and TSRC may be examples of a residual coding scheme. For coding coefficients (e.g., values of a transform block or transform skip block), video encoder 200 may encode a significance flag (e.g., to indicate whether the absolute value of a coefficient is non-zero), greater than flags (e.g., to indicate whether the absolute value of a coefficient is greater than 1, greater than 2, and so forth), and a sign flag (e.g., whether positive or negative) for one or more of the residual values. Video decoder 300 may decode the significance flag, the greater than flags, and sign flags to determine the coefficients.

There may be some differences between TRCC and TSRC. As one example, the number of greater than flags for TRCC and TSRC may be different. One of TRCC and TSRC may utilize a parity flag (e.g., indicative of whether the coefficient is odd or even), and the other one of TRCC and TSRC may not utilize a parity flag. In TSRC, the last coefficient position may not be coded and coefficients are scanned in forward direction. In TRRC, the last position may be coded and the scan may be from last to first coefficient. These are some example differences between TRCC and TSRC, but the example techniques are not limited to these differences.

In some examples, either TRCC or TSRC can be used for residual coding of transform skipped blocks. For example, there are two residual coding schemes in the VVC Draft 8 specification. A first one of the two residual coding schemes is TRCC and the second one of the two residual coding schemes is TSRC. In VVC Draft 8, transform skipping is signalled explicitly using the TS mode flag as part of MTS (multiple transform selection) index. In some examples, transform skipping is implicitly selected if BDPCM (block-based delta pulse code modulation) mode is selected. As noted above, when transform is skipped, either TRCC or TSRC is used for residual coding of transform skipped blocks.

The signalling of which method to use (e.g., either TRCC or TSRC) is signalled through the slice_ts_residual_coding_disabled_flag element in the slice header. When slice_ts_residual_coding_disabled_flag is set to 1, then transform coefficient coding TRCC is used for coding of transform skipped blocks.

To reiterate, a block may be encoded or decoded with transform or with transform skip. If encoded or decoded with transform, video encoder 200 and video decoder 300 may utilize TRCC to encode or decode residual values (e.g., coefficients after transform) for the block. If encoded or decoded with transform skip, video encoder 200 and video decoder 300 may utilize TRCC or TSRC to encode or decode the residual values (e.g., coefficients without transform) for the block. In such examples, video encoder 200 may signal a flag (e.g., slice_ts_residual_coding_disabled_flag) that indicates whether TSRC is to be used (e.g., slice_ts_residual_coding_disabled_flag is 0) or whether TRCC is to be used (e.g., slice_ts_residual_coding_disabled_flag is 1).

In VVC Draft 8, dependent quantization (DQ) or sign data hiding (SDH) can be used for transform skip blocks when TRCC is selected. TSRC does not use dependent quantization coding or sign data hiding schemes.

In VVC, lossless coding may be achieved only if transform is skipped in some examples. Dependent quantization (DQ) and sign data hiding (SDH) are implicitly lossy operations. Dependent quantization and sign data hiding is enabled at picture level or at higher levels like the sequence parameter set (SPS) level.

In some examples, it may be desirable to mix lossy and lossless coding in a slice and at the same time use TRCC for coefficient coding. However, in such cases, the use of DQ or SDH becomes prohibited for an entire picture/slice.

Stated another way, there may be one or more lossy coding tools that are enabled at a picture level or slice level for a picture or slice, and examples of the one or more lossy coding tools include DQ and SDH. If TRCC is used and some of the blocks in the picture or slice are lossless coded using transform skip (e.g., transform is skipped for the residual blocks of the blocks in the picture or slice), then DQ and SDH may not be available since DQ and SDH are part of lossy coding and would cause some loss in the video data if applied to a transform skip block. However, there may be a benefit in allowing for DQ and SDH for other blocks (e.g., not transform skip blocks) in the same picture or slice as the transform skip block.

This disclosure describes example techniques to enable use of one or more lossy coding tools (e.g., DQ or SDH) at a picture/slice level but disable the one or more lossy coding tools at a transform skipped block level to enable mixed lossy and lossless coding with TRCC coding. Accordingly, this disclosure describes examples where video encoder 200 and video decoder 300 may be configured to determine that one or more lossy coding tools (e.g., DQ or SDH) are enabled at a picture level or slice level for a picture or slice that includes a block, determine that the block is coded (e.g., encoded or decoded) with transform skip, bypass use of the one or more lossy coding tools (e.g., not perform DQ or SDH) for the block based on the determination that the one or more lossy coding tools are enabled at the picture level or slice level for the picture or slice that includes the block and the determination that the block is coded with transform skip, and perform a residual coding scheme (e.g., TRCC). In some examples, the residual coding scheme may be based on the bypassing of the one or more lossy coding tools. For instance, the residual coding scheme is one residual coding scheme between transform coefficient coding (TRCC) and transform skip residual coding (TSRC).

In the above example, where DQ or SDH, as two examples of lossy coding tools, are enabled for a picture or slice, and a block (e.g., a first block) is transform skip, then use of the lossy coding tools (e.g., DQ and SDH) is bypassed for the first block. In one or more examples, video encoder 200 and video decoder 300 may determine that a second block, in the same picture or slice as the first block that is coded with transform skip, is not coded with transform skip (e.g., a DCT or DST is performed on the residual block), and use the one or more lossy coding tools for the second block based on the determination that the one or more lossy coding tools are enabled at the picture level or slice level for the picture or slice that includes the first block and the second block and the determination that the second block is not coded with transform skip. In this way, when TRCC is used, it may be possible to have both lossy and lossless coded blocks in the same picture or slice.

In the above examples, DQ and SDH are examples of lossy coding tools. Quantization, in general, tends to be lossy coding tool. For instance, in quantization, values between two boundary values (e.g., defined by the quantization parameter) are quantized to one value between the two boundary values. In dependent quantization (DQ), there may be two or more quantization schemes. A first quantization scheme may define a first value between the two boundary values to which values between the two boundary values are quantized. A second quantization scheme may define a second value, possibly different than the first value, between the two boundary values to which values between the two boundary values are quantized, and so forth. In some examples, the boundaries of the second quantization scheme may be different than the boundaries of the first quantization scheme (e.g., overlapping or shifted boundaries). In DQ, video encoder 200 and video decoder 300 may switch between the two or more quantization schemes for quantization.

In sign data hiding (SDH), video encoder 200 may be configured to not encode the signFlag (e.g., whether positive or negative) of the first non-zero coefficient. Instead, the sign value of the first non-zero coefficient is embedded in the parity of the sum of the levels of the transform coefficient in a coding group using a predefined convention (e.g., an even parity corresponds to plus (“+”) sign and an odd parity corresponds to a minus (“−”) sign).

The following describes example ways in which to disable one or more lossy coding tools (e.g., dependent quantization (DQ) and sign data hiding (SDH)) methods for transform skipped blocks that are using TRCC. In one example, disabling use of the one or more lossy coding tools (e.g., DQ and SDH) methods for transform skipped blocks that are using TRCC may be achieved by applying the one or more lossy coding tools (e.g., DQ and/or SDH) for a block or a TU on a condition that transform mode is not transform skip, when TRCC coding method is utilized.

The changes required to support this in VVC Draft 8 are shown below. In the below text that is between <ADD> to </ADD> represents text that is added to VVC Draft 8 to disable one or more lossy coding tools (e.g., DQ and SDH) methods for transform skipped blocks that are using TRCC.

7.3.10.11 Residual coding syntax

| residual_coding( x0, y0, log2TbWidth, log2TbHeight, cIdx ) { | Descriptor |
|---|---|
| if( sps_mts_enabled_flag && cu_sbt_flag && cIdx = = 0 && | |
| log2TbWidth = = 5 && log2TbHeight < 6 ) | |
| log2ZoTbWidth = 4 | |
| else | |
| log2ZoTbWidth = Min( log2TbWidth, 5 ) | |
| if( sps_mts_enabled_flag && cu_sbt_flag && cIdx = = 0 && | |
| log2TbWidth < 6 && log2TbHeight = = 5 ) | |
| log2ZoTbHeight = 4 | |
| else | |
| log2ZoTbHeight = Min( log2TbHeight, 5 ) | |
| if( log2TbWidth > 0 ) | |
| last_sig_coeff_x_prefix | ae(v) |
| if( log2TbHeight > 0 ) | |
| last_sig_coeff_y_prefix | ae(v) |
| if( last_sig_coeff_x_prefix > 3 ) | |
| last_sig_coeff_x_suffix | ae(v) |
| if( last_sig_coeff_y_prefix > 3 ) | |
| last_sig_coeff_y_suffix | ae(v) |
| log2TbWidth = log2ZoTbWidth | |
| log2TbHeight = log2ZoTbHeight | |
| remBinsPass1 = ( ( 1 << ( log2TbWidth + log2TbHeight ) ) * 7 ) >> 2 | |
| log2SbW = ( Min( log2TbWidth, log2TbHeight ) < 2 ? 1 : 2 ) | |
| log2SbH = log2SbW | |
| if( log2TbWidth + log2TbHeight > 3 ) | |
| if( log2TbWidth < 2 ) { | |
| log2SbW = log2TbWidth | |
| log2SbH = 4 − log2SbW | |
| } else if( log2TbHeight < 2 ) { | |
| log2SbH = log2TbHeight | |
| log2SbW = 4 − log2SbH | |
| } | |
| numSbCoeff = 1 << ( log2SbW + log2SbH ) | |
| lastScanPos = numSbCoeff | |
| lastSubBlock = ( 1 << ( log2TbWidth + log2TbHeight − ( log2SbW + log2SbH ) ) ) − 1 | |
| do { | |
| if( lastScanPos = = 0) { | |
| lastScanPos = numSbCoeff | |
| lastSubBlock− − | |
| } | |
| lastScanPos− − | |
| xS = DiagScanOrder[ log2TbWidth − log2SbW ][ log2TbHeight − log2SbH ] | |
| [ lastSubBlock ][ 0 ] | |
| yS = DiagScanOrder[ log2TbWidth − log2SbW ][ log2TbHeight − log2SbH ] | |
| [ lastSubBlock ][ 1 ] | |
| xC = ( xS << log2SbW ) + DiagScanOrder[ log2SbW ][ log2SbH ][ lastScanPos ][ 0 ] | |
| yC = ( yS << log2SbH ) + DiagScanOrder[ log2SbW ][ log2SbH ][ lastScanPos ][ 1 ] | |
| } while( ( xC != LastSignificantCoeffX ) ∥ ( YC != LastSignificantCoeffY ) ) | |
| if( lastSubBlock = = 0 && log2TbWidth >= 2 && log2TbHeight >= 2 && | |
| !transform_skip_flag[ x0 ][ y0 ][ cIdx ] && lastScanPos > 0 ) | |
| LfnstDcOnly = 0 | |
| if( ( lastSubBlock > 0 && log2TbWidth >= 2 && log2TbHeight >= 2 ) ∥ | |
| ( lastScanPos > 7 && ( log2TbWidth = = 2 ∥ log2TbWidth = = 3 ) && | |
| log2TbWidth = = log2TbHeight ) ) | |
| LfnstZeroOutSigCoeffFlag = 0 | |
| if( ( lastSubBlock > 0 ∥ lastScanPos > 0 ) && cIdx = = 0 ) | |
| MtsDcOnly = 0 | |
| QState = 0 | |
| for( i = lastSubBlock; i >= 0; i− − ) { | |
| startQStateSb = QState | |
| xS = DiagScanOrder[ log2TbWidth − log2SbW ][ log2TbHeight − log2SbH ] | |
| [ i ][ 0 ] | |
| yS = DiagScanOrder[ log2TbWidth − log2SbW ][ log2TbHeight − log2SbH ] | |
| [ i ][ 1 ] | |
| inferSbDcSigCoeffFlag = 0 | |
| if( i < lastSubBlock && i > 0 ) { | |
| coded_sub_block_flag[ xS ][ yS ] | ae(v) |
| inferSbDcSigCoeffFlag = 1 | |
| } | |
| if( coded_sub_block_flag[ xS ][ yS ] && ( xS > 3 ∥ yS > 3 ) && cIdx = = 0 ) | |
| MtsZeroOutSigCoeffFlag = 0 | |
| firstSigScanPosSb = numSbCoeff | |
| lastSigScanPosSb = −1 | |
| firstPosMode0 = ( i = = lastSubBlock ? lastScanPos : numSbCoeff − 1 ) | |
| firstPosMode1 = firstPosMode0 | |
| for( n = firstPosMode0; n >= 0 && remBinsPass1 >= 4; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( coded_sub_block_flag[ xS ][ yS ] && ( n > 0 ∥ !inferSbDcSigCoeffFlag ) && | |
| ( xC != LastSignificantCoeffX ∥ yC != Last SignificantCoeffY ) ) { | |
| sig_coeff_flag[ xC ][ yC ] | ae(v) |
| remBinsPass1− − | |
| if( sig_coeff_flag[ xC ][ yC ] ) | |
| inferSbDcSigCoeffFlag = 0 | |
| } | |
| if( sig_coeff_flag[ xC ][ yC ] ) { | |
| abs_level_gtx_flag[ n ][ 0 ] | ae(v) |
| remBinsPass1− − | |
| if( abs_level_gtx_flag[ n ][ 0 ] ) { | |
| par_level_flag[ n ] | ae(v) |
| remBinsPass1− − | |
| abs_level_gtx_flag[ n ][ 1 ] | ae(v) |
| remBinsPass1− − | |
| } | |
| if( lastSigScanPosSb = = −1 ) | |
| lastSigScanPosSb = n | |
| firstSigScanPosSb = n | |
| } | |
| AbsLevelPass1[ xC ][ yC ] = sig_coeff_flag[ xC ][ yC ] + par_level_flag[ n ] + | |
| abs_level_gtx_flag[ n ][ 0 ] + 2 * abs_level_gtx_flag[ n ][ 1 ] | |
| if( ph_dep_quant_enabled_flag <ADD> && !transform_skip_flag[ x0 ][ y0 ][cIdx ] | |
| </ADD>) | |
| QState = QStateTransTable[ QState ][ AbsLevelPass1[ xC ][ yC ] & 1 ] | |
| firstPosModel = n − 1 | |
| } | |
| for( n = firstPosMode0; n > firstPosModel; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( abs_level_gtx_flag[ n ][ 1 ] ) | |
| abs_remainder[ n ] | ae(v) |
| AbsLevel[ xC ][ yC ] = AbsLevelPass1[ xC ][ yC ] +2 * abs_remainder[ n ] | |
| } | |
| for( n = firstPosMode1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( coded_sub_block_flag[ xS ][ yS ] ) | |
| dec_abs_level[ n ] | ae(v) |
| if( AbsLevel[ xC ][ yC ] > 0 ) { | |
| if( lastSigScanPosSb = = −1 ) | |
| lastSigScanPosSb = n | |
| firstSigScanPosSb = n | |
| } | |
| if( ph_dep_quant_enabled_flag <ADD> && !transform_skip_flag[ x0 ][ y0 ][ cIdx ] | |
| </ADD> ) | |
| QState = QStateTransTable[ QState ][ AbsLevel[ xC ][ yC ] & 1 ] | |
| } | |
| if( ph_dep_quant_enabled_flag ∥ !pic_sign_data_hiding_enabled_flag <ADD> ∥ | |
| transform_skip_flag[ x0 ][ y0 ][ cIdx ] </ADD>) | |
| signHidden = 0 | |
| else | |
| signHidden = ( lastSigScanPosSb − firstSigScanPosSb > 3 ? 1: 0 ) | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( ( AbsLevel[ xC ][ yC ] > 0 ) && | |
| ( !signHidden ∥ ( n != firstSigScanPosSb ) ) ) | |
| coeff sign_flag[ n ] | ae(v) |
| } | |
| if( ph_dep_quant_enabled_flag <ADD> && !transform_skip_flag[ x0 ][ y0 ][ cIdx ] | |
| </ADD>) { | |
| QState = startQStateSb | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( AbsLevel[ xC ][ yC ] > 0 ) | |
| TransCoeffLevel[ x0 ][ y0 ][ cIdx ][ xC ][ yC ] = | |
| ( 2 * AbsLevel[ xC ][ yC ] − ( QState > 1 ? 1 : 0 ) ) * | |
| ( 1 − 2 * coeff_sign_flag[ n ] ) | |
| QState = QStateTransTable[ QState ][ AbsLevel[ xC ][ yC ] & 1 ] | |
| } else { | |
| sumAbsLevel = 0 | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( AbsLevel[ xC ][ yC ] > 0 ) { | |
| TransCoeffLevel[ x0 ][ y0 ][ cIdx ][ xC ][ yC ] = | |
| AbsLevel[ xC ][ yC ] * ( 1 − 2 * coeff_sign_flag[ n ] ) | |
| if( signHidden ) { | |
| sumAbsLevel += AbsLevel[ xC ][ yC ] | |
| if( ( n = = firstSigScanPosSb ) && ( sumAbsLevel % 2 ) = = 1 ) ) | |
| TransCoeffLevel[ x0 ][ y0 ][ cIdx ][ xC ][ yC ] = | |
| −TransCoeffLevel[ x0 ][ y0 ][ cIdx ][ xC ][ yC ] | |
| } | |
| } | |
| } | |
| } | |
| } | |
| } | |

ph_dep_quant_enabled_flag equal to 0 specifies that dependent quantization is disabled for the current picture. ph_dep_quant_enabled_flag equal to 1 specifies that dependent quantization is enabled for the current picture. When ph_dep_quant_enabled_flag is not present, it is inferred to be equal to 0.

pic_sign_data_hiding_enabled_flag equal to 0 specifies that sign bit hiding is disabled for the current picture. pic_sign_data_hiding_enabled_flag equal to 1 specifies that sign bit hiding is enabled for the current picture. When pic_sign_data_hiding_enabled_flag is not present, it is inferred to be equal to 0.

transform_skip_flag[x0][y0][cIdx] specifies whether a transform is applied to the associated transform block or not. The array indices x0, y0 specify the location (x0, y0) of the top-left luma sample of the considered transform block relative to the top-left luma sample of the picture. The array index cIdx specifies an indicator for the colour component; it is equal to 0 for Y, 1 for Cb, and 2 for Cr. transform_skip_flag[x0][y0][cIdx] equal to 1 specifies that no transform is applied to the associated transform block. transform_skip_flag[x0][y0][cIdx] equal to 0 specifies that the decision whether transform is applied to the associated transform block or not depends on other syntax elements.

In one or more examples, video encoder 200 may disable dependent quantization and sign data hiding methods for transform skipped blocks that use TRCC for coding of residuals. Alternatively or additionally, a slice header, picture header (PH), PPS, SPS level flags may indicate whether dependent quantization and or sign data hiding in combination of transform skip is enabled or not. In case of signalling in a slice header, the presence of existence of these flags may be conditioned on a transform coefficient method indicator, such as slice_ts_residual_coding_disabled_flag being equal 1. Similarly, conditioning of the presence of these flags in higher levels, in one example other parameters sets above slice header, can be conditioned on a flag indicating whether TS residual coding is disabled.

In one or more examples described in this disclosure, video encoder 200 may determine that one or more lossy coding tools are enabled at a picture level or slice level for a picture or slice that includes a current block. Examples of the one or more lossy coding tools include dependent quantization (DQ) and sign data hiding (SDH).

For example, video encoder 200 may determine a value of ph_dep_quant_enabled_flag. In this example, the ph_dep_quant_enabled_flag is part of the picture header, but dep_quant_enabled_flag may be part of the slice header in some examples. A value of 1 for ph_dep_quant_enabled_flag may indicate that dependent DQ is enabled, and a value of 0 for ph_dep_quant_enabled_flag may indicate that dependent DQ is disabled. Video encoder 200 may signal the value for ph_dep_quant_enabled_flag.

As another example, video encoder 200 may determine a value of pic_sign_data_hiding_enabled_flag. In this example, pic_sign_data_hiding_enabled_flag may be part of the picture header, but sign data hiding enabled flag may be part of the slice header in some examples. A value of 1 for pic_sign_data_hiding_enabled_flag may indicate that SDH is enabled, and a value of 0 for pic_sign_data_hiding_enabled_flag may indicate that SDH is disabled. Video encoder 200 may signal the value for pic_sign_data_hiding_enabled_flag.

Video encoder 200 may also determine that the current block is encoded with transform skip. For instance, video encoder 200 may determine a value for transform_skip_flag that indicates whether transform skip is enabled for the current block or not.

In accordance with one or more examples, video encoder 200 may bypass use of the one or more lossy coding tools for the current block based on the determination that the current block is encoded with transform skip. That is, if the current block is encoded with transform skip, video encoder 200 may not perform DQ or SDH on the current block.

Video encoder 200 may perform a residual coding scheme (e.g., based on the bypassing) to generate values indicative of a residual block. The residual coding scheme may be one of transform coefficient coding (TRCC) and transform skip residual coding (TSRC). Video encoder 200 may signal the values indicative of the residual block for video decoder 300 to reconstruct the current block.

Similarly, video decoder 300 may determine that one or more lossy coding tools are enabled at a picture level or slice level for a picture or slice that includes a current block. Examples of the one or more lossy coding tools include dependent quantization (DQ) and sign data hiding (SDH).

For example, video decoder 300 may determine a value of ph_dep_quant_enabled_flag. For instance, video decoder 300 may parse the ph_dep_quant_enabled_flag in the picture header, although parsing dep_quant_enabled_flag in the slice header is possible. A value of 1 for ph_dep_quant_enabled_flag may indicate that dependent DQ is enabled, and a value of 0 for ph_dep_quant_enabled_flag may indicate that dependent DQ is disabled.

As another example, video decoder 300 may determine a value of pic_sign_data_hiding_enabled_flag. For instance, video decoder 300 may parse the pic_sign_data_hiding_enabled_flag in the picture header, although parsing sign_data_hiding_enabled_flag in the slice header is possible. A value of 1 for pic_sign_data_hiding_enabled_flag may indicate that SDH is enabled, and a value of 0 for pic_sign_data_hiding_enabled_flag may indicate that SDH is disabled.

Video decoder 300 may also determine that the current block is decoded with transform skip. For instance, video decoder 300 may parse a value for transform_skip_flag that indicates whether transform skip is enabled for the current block or not.

In accordance with one or more examples, video decoder 300 may bypass use of the one or more lossy coding tools for the current block based on the determination that the current block is decoded with transform skip. That is, if the current block is decoded with transform skip, video decoder 300 may not perform DQ or SDH on the current block.

Video decoder 300 may perform a residual coding scheme (e.g., based on the bypassing) to generate a residual block. The residual coding scheme may be one of transform coefficient coding (TRCC) and transform skip residual coding (TSRC). Video decoder 300 may reconstruct the current block based on the residual block. For example, video decoder 300 may also determine a prediction block and add the prediction block to the residual block to reconstruct the current block.

In this way, even if DQ or SDH is enabled at a picture or slice level, video encoder 200 and video decoder 300 may selectively bypass DQ or SDH for blocks in the picture or slice for which transform is skipped. For example, the current block may be considered as a first block. In some examples, video encoder 200 or video decoder 300 may determine that a second block, in the same picture or slice as the first block that is coded with transform skip, is not coded with transform skip and use the one or more lossy coding tools for the second block based on the determination that the second block is not coded with transform skip.

Accordingly, lossy and lossless coding techniques may be mixed in a picture or slice. For example, video encoder 200 and video decoder 300 may bypass use of the one or more lossy coding tools for the block based on the determination that the block is coded with transform skip and the determination that the one or more lossy coding tools are enabled at the picture level or slice level for the picture or slice that includes the current block. Also, video encoder 200 and video decoder 300 may use the one or more lossy coding tools for the second block based on the determination that the second block is not coded with transform skip and the determination that the one or more lossy coding tools are enabled at the picture level or slice level for the picture or slice that includes the first block and the second block.

That is, even though video encoder 200 and video decoder 300 may determine that one or more lossy coding tools (e.g., SDH and DQ) are enabled at the picture or slice level, video encoder 200 and video decoder 300 may still selectively bypass using or use the one or more lossy coding tools for blocks in the picture or slice. In this way, the example techniques provide for operational flexibility of video encoder 200 and the techniques described in this disclosure allow utilization of lossless coding where video quality preservation may be desired, and utilization of lossy coding tools in instances where reduction in signaling may be desired.

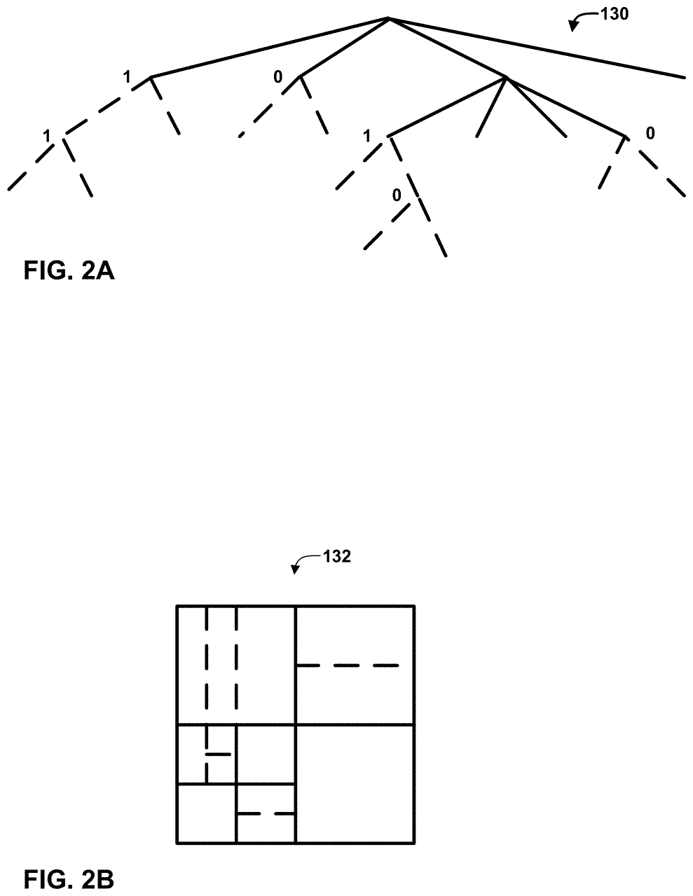

FIGS. 2A and 2B are conceptual diagrams illustrating an example quadtree binary tree (QTBT) structure 130, and a corresponding coding tree unit (CTU) 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, because quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), then the nodes can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the quadtree leaf node is 128×128, the leaf quadtree node will not be further split by the binary tree, because the size exceeds the MaxBTSize (i.e., 64×64, in this example). Otherwise, the quadtree leaf node will be further partitioned by the binary tree. Therefore, the quadtree leaf node is also the root node for the binary tree and has the binary tree depth as 0. When the binary tree depth reaches MaxBTDepth (4, in this example), no further splitting is permitted. When the binary tree node has a width equal to MinBTSize (4, in this example), it implies that no further vertical splitting is permitted. Similarly, a binary tree node having a height equal to MinBTSize implies that no further horizontal splitting is permitted for that binary tree node. As noted above, leaf nodes of the binary tree are referred to as CUs, and are further processed according to prediction and transform without further partitioning.

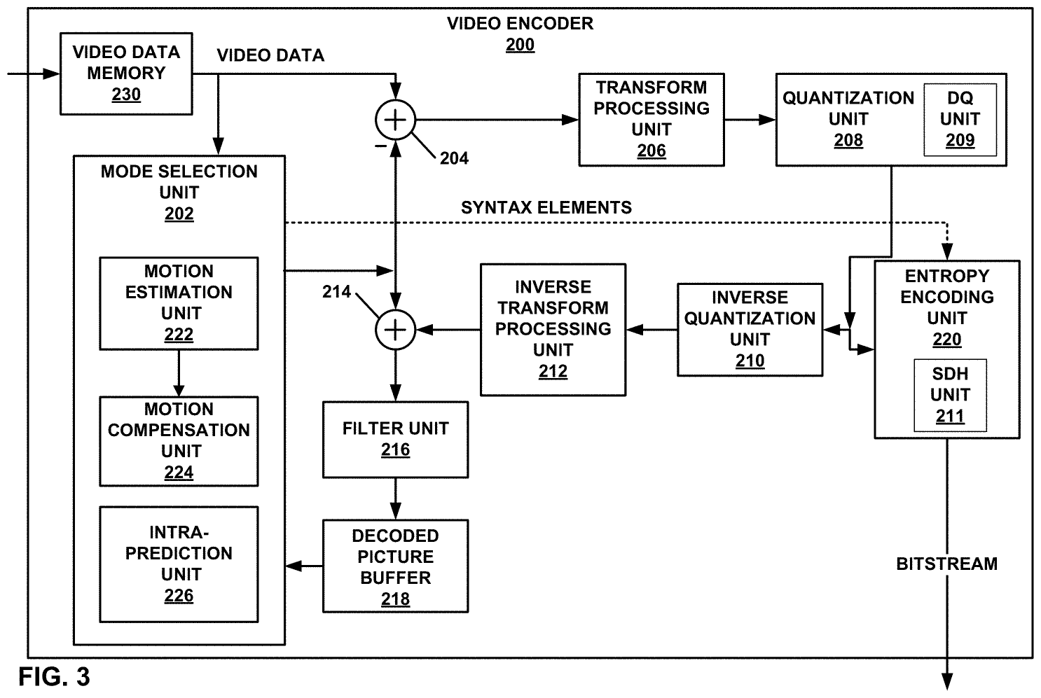

FIG. 3 is a block diagram illustrating an example video encoder 200 that may perform the techniques of this disclosure. FIG. 3 is provided for purposes of explanation and should not be considered limiting of the techniques as broadly exemplified and described in this disclosure. For purposes of explanation, this disclosure describes video encoder 200 according to the techniques of VVC (ITU-T H.266, under development), and HEVC (ITU-T H.265). However, the techniques of this disclosure may be performed by video encoding devices that are configured to other video coding standards.

In the example of FIG. 3, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. As illustrated, quantization unit 208 includes dependent quantization (DQ) unit 209 configured to perform dependent quantization, and entropy encoding unit 220 includes sign data hiding (SDH) unit 211 configured to perform sign data hiding. DQ unit 209 may perform dependent quantization utilizing the techniques described above, and SDH unit 211 may perform sign data hiding utilizing the techniques described above.

DQ unit 208 and SDH unit 211 are examples of lossy coding tools. In one or more examples, mode selection unit 202 may determine at picture level or slice level, as two examples, that lossy coding tools are enabled. However, in one or more examples, the operations of DQ unit 208 and SDH unit 211 may be bypassed for blocks that are to be coded in lossless mode (e.g., with transform skip).

Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, of FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 3 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the QTBT structure or the quad-tree structure of HEVC described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as a few examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block (e.g., for transform skip blocks).

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206. In some examples, quantization unit 208 does not apply quantization to a residual block (e.g., for transform skip blocks).

Inverse quantization unit 210 and inverse transform processing unit 212 may apply inverse quantization and inverse transforms to a quantized transform coefficient block, respectively, to reconstruct a residual block from the transform coefficient block. If transform and/or quantization is skipped, then the inverse of such operations by inverse quantization unit 210 and inverse transform processing unit 212 may be skipped.

Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying an MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to determine that one or more lossy coding tools are enabled at a picture level or slice level for a picture or slice that includes a block, determine that the block is coded with transform skip, bypass use of the one or more lossy coding tools for the block based on the determination that the one or more lossy coding tools are enabled at the picture level or slice level for the picture or slice that includes the block and the determination that the block is coded with transform skip, and perform a residual coding scheme.

For example, mode selection unit 202 may determine that one or more lossy coding tools are enabled at a picture level or slice level for a picture or slice that includes a current block. Mode selection unit 202 may also determine that the current block is encoded with transform skip. In this example, the operations of transform processing unit 206 and/or quantization unit 208, including DQ unit 209, are bypassed for the current block. In addition, the operations of SDH unit 211 may be bypassed for the current block.

That is, even though DQ and SDH are enabled at the picture or slice level, for the current block that is in the picture or slice, the operations for DQ unit 209 and SDH unit 211 may be bypassed for the current block that is encoded with transform skip. In this way, DQ and SDH can be enabled at the picture level or slice level, but a block-by-block determination can be made as to whether to bypass DQ and SDH, such as for blocks with transform skip enabled. Enabling the lossy coding tools at the picture level or slice level may refer to information signaled that is applicable to the entirety of the picture or slice, such as in a picture header, slice header, or within one or more parameter sets, such as a picture parameter set (PPS) or sequence parameter set (SPS).

Entropy encoding unit 220 may perform a residual coding scheme to generate residual information such as significance flag information, greater than flag information, parity information, etc. In some examples, the residual coding scheme may be based on the bypassing. Examples of the residual coding scheme include the TSRC and TRCC, and may be TRCC in some examples where transform skip is performed but lossy coding tools are enabled at the picture or slice level. For instance, if lossy coding tools are enabled, then TRCC may be available in some examples, and TSRC may not be available in those examples. Accordingly, without signaling, it may be possible to determine that TRCC is to be used on blocks with transform skip enabled if the lossy coding tools are enabled at the picture or slice level.

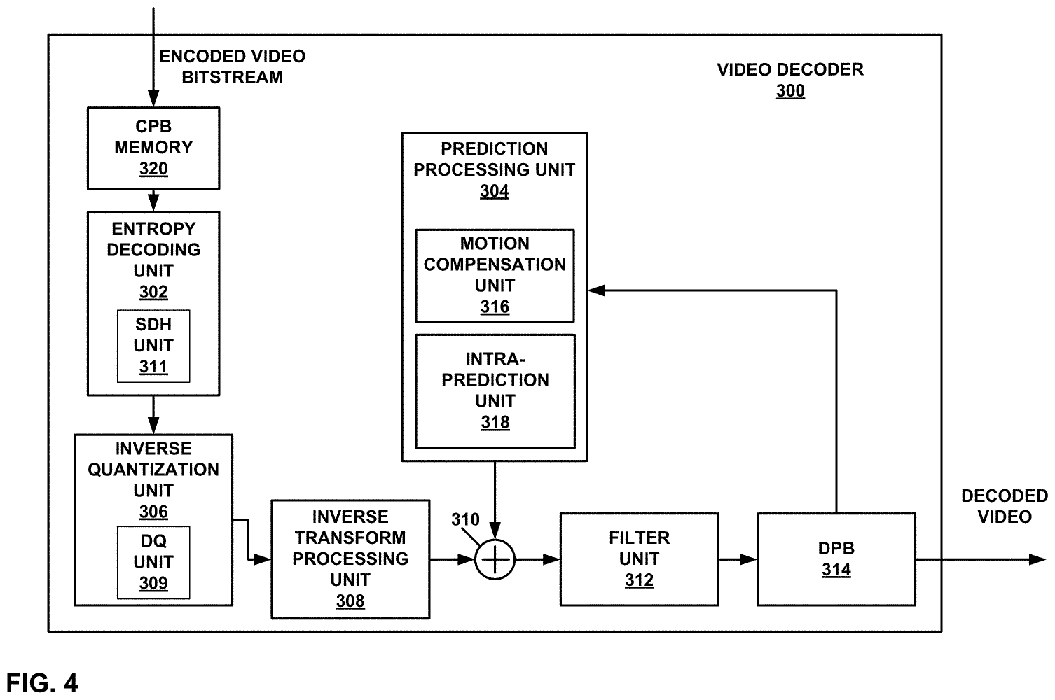

FIG. 4 is a block diagram illustrating an example video decoder 300 that may perform the techniques of this disclosure. FIG. 4 is provided for purposes of explanation and is not limiting on the techniques as broadly exemplified and described in this disclosure. For purposes of explanation, this disclosure describes video decoder 300 according to the techniques of VVC (ITU-T H.266, under development), and HEVC (ITU-T H.265). However, the techniques of this disclosure may be performed by video coding devices that are configured to other video coding standards.

In the example of FIG. 4, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. As illustrated, inverse quantization unit 306 includes dependent quantization (DQ) unit 309 configured to perform dependent quantization, and entropy encoding unit 302 includes sign data hiding (SDH) unit 311 configured to perform sign data hiding. DQ unit 309 may perform dependent quantization utilizing the techniques described above, and SDH unit 311 may perform sign data hiding utilizing the techniques described above.

DQ unit 309 and SDH unit 311 are examples of lossy coding tools. In one or more examples, prediction processing unit 304 may determine at picture level or slice level, as two examples, that lossy coding tools are enabled. However, in one or more examples, the operations of DQ unit 309 and SDH unit 311 may be bypassed for blocks that are to be coded in lossless mode (e.g., with transform skip).

Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, of FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 4 are illustrated to assist with understanding the operations performed by video decoder 300. The units may be implemented as fixed-function circuits, programmable circuits, or a combination thereof. Similar to FIG. 3, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients. In some examples, the operations of inverse quantization unit 306 may be bypassed such as for transform skip blocks.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block. For transform skip blocks, inverse transform processing unit 308 may not perform any inverse transform operations, and inverse transform processing unit 308 may be bypassed.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 3).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 3). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to determine that one or more lossy coding tools are enabled at a picture level or slice level for a picture or slice that includes a block, determine that the block is coded with transform skip, bypass use of the one or more lossy coding tools for the block based on the determination that the one or more lossy coding tools are enabled at the picture level or slice level for the picture or slice that includes the block and the determination that the block is coded with transform skip, and perform a residual coding scheme.

For example, prediction processing unit 304 may determine that one or more lossy coding tools are enabled at a picture level or slice level for a picture or slice that includes a current block (e.g., based on signaling from video encoder 200). Prediction processing unit 304 may also determine that the current block is decoded with transform skip (e.g., based on signaling from video encoder 200). In this example, the operations of inverse quantization unit 306, including DQ unit 309, and/or inverse transform processing unit 308 are bypassed for the current block. In addition, the operations of SDH unit 311 may be bypassed for the current block.

For example, entropy decoding unit 302 may perform a residual coding scheme to generate a residual block. Prediction processing unit 304 may determine that even though DQ and SDH are enabled at the picture or slice level, for the current block that is in the picture or slice, the lossy coding tools are not to be used because the current block is decoded with transform skip (e.g., lossless). Accordingly, prediction processing unit 304 may bypass the operations for DQ unit 309 and SDH unit 311 for the current block that is decoded with transform skip. In this way, DQ and SDH can be enabled at the picture level or slice level, but a block-by-block determination can be made as to whether to bypass DQ and SDH, such as for blocks with transform skip enabled. Enabling the lossy coding tools at the picture level or slice level may refer to information signaled that is applicable to the entirety of the picture or slice, such as in a picture header, slice header, or within one or more parameter sets, such as a picture parameter set (PPS) or sequence parameter set (SPS).

As described, in some examples, entropy decoding unit 302 may perform a residual coding scheme to generate a residual block. For instance, entropy decoding unit 302 may decode significance flags, greater than flags, parity flags, etc. to determine the residual values for a residual block of the current block. Which flags are decoded may be based on the residual coding scheme. In some examples, the residual coding scheme may be based on the bypassing. Examples of the residual coding scheme include the TSRC and TRCC, and may be TRCC in some examples where transform skip is performed but lossy coding tools are enabled at the picture or slice level. For instance, if lossy coding tools are enabled, then TRCC may be available in some examples, and TSRC may not be available in those examples. Accordingly, without signaling, it may be possible to determine that TRCC is to be used on blocks with transform skip enabled if the lossy coding tools are enabled at the picture or slice level.

For the current block, the operations of SDH unit 311 may be bypassed, and entropy decoding unit 302 may decode sign data. The operations of DQ unit 309 may be bypassed, and in some examples, all operations of inverse quantization unit 306 may be bypassed. The operations of inverse transform processing unit 308 may be bypassed for the current block. Reconstruction unit 310 may receive the residual block and reconstruct the current block based on the residual block (e.g., add the prediction block to the residual block to reconstruct the current block).

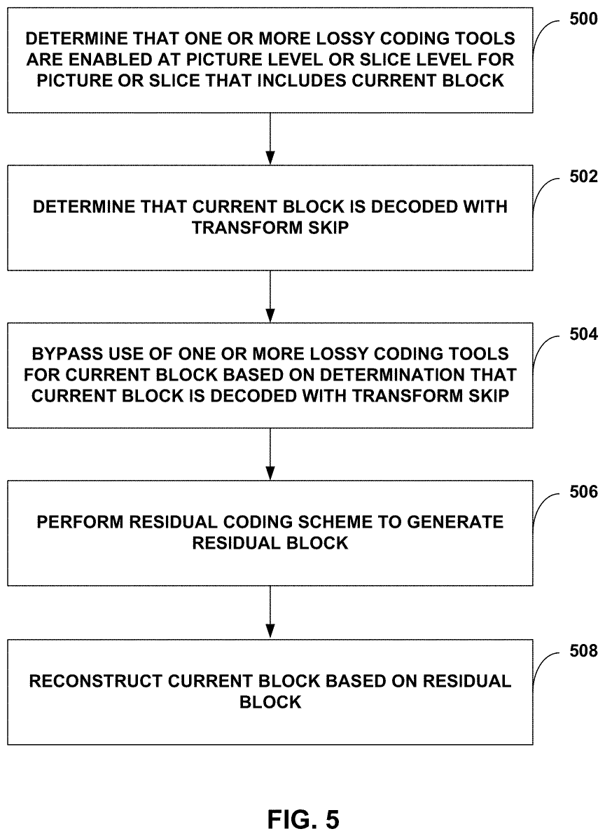

FIG. 5 is a flowchart illustrating an example method of decoding video data. For ease of description, the example of FIG. 5 is described with respect to FIG. 4. For instance, memory, such as CPB memory 320, DPB 314, memory 120, or some other memory, may be configured to store video data, such as syntax elements that are decoded for reconstructing a current block of the video data.

Prediction processing unit 304 may determine that one or more lossy coding tools are enabled at a picture level or slice level for a picture or slice that includes a current block (500). The one or more lossy coding tools may include at least one of dependent quantization or sign data hiding. As one example, entropy decoding unit 302 may decode the ph_dep_quant_enabled_flag and the pic_sign_data_hiding_enabled_flag from a bitstream signaled by video encoder 200, where the ph_dep_quant_enabled_flag indicates whether dependent quantization is enabled, and pic_sign_data_hiding_enabled_flag indicates whether sign data hiding is enabled. However, there may be other ways in which to signal information indicative of whether the lossy coding tools (e.g., data quantization and sign data hiding) are enabled, such as in a PPS or SPS, or some other parameter set.

Prediction processing unit 304 may determine that the current block is decoded with transform skip (502). For example, prediction processing unit 304 may determine that the current block is decoded (e.g., is to be decoded) with transform skip based on the transform_skip_flag[x0][y0][cIdx], but other ways in which to determine that the current block is decoded with transform skip are possible.

Prediction processing unit 304 may bypass use of the one or more lossy coding tools for the current block based on the determination that the current block is decoded with transform skip (504). For example, prediction processing unit 304 may bypass the operations of SDH unit 311 and DQ unit 309.

Accordingly, prediction processing unit 304 may bypass the use of the one or more lossy coding tools for the block based on the determination that the block is coded with transform skip and the determination that the one or more lossy coding tools are enabled at the picture level or slice level for the picture or slice that includes the current block. That is, even though the lossy coding tools are enabled, prediction processing unit 304 may still bypass the use of the lossy coding tools.

Entropy decoding unit 302 may perform a residual coding scheme to generate a residual block (506). Examples of the residual coding scheme include TRCC and TSRC. However, in some examples, entropy decoding unit 302 may be configured to perform TRCC for the current block (e.g., automatically configured to perform TRCC for the current block). For instance, TRCC may be available, and TSRC may not be available for the current block that is decoded with transform skip. Accordingly, without signaling, entropy encoding unit 302 may determine to use TRCC. In this way, in some examples, the residual coding scheme may be based on the bypassing of the use of the one or more lossy coding tools.

Reconstruction unit 310 may reconstruct the current block based on the residual block (508). For example, reconstruction unit 310 may add the residual block to the prediction block to reconstruct the current block.

In the above, the current block was decoded with transform skip. The current block may be a first block in the picture or slice for which the lossy coding tools are enabled. Prediction processing unit 304 may determine that a second block, in the same picture or slice as the first block that is decoded (e.g., to be decoded) with transform skip, is not decoded with transform skip (e.g., not to be decoded with transform skip). For instance, the transform_skip_flag[x0][y0][cIdx] for the second block may indicate that transform is not skipped for the second block, and the ph_dep_quant_enabled_flag and/or the pic_sign_data_hiding_enabled_flag indicated by the DQ and/or SDH are enabled for the picture or slice that includes both the first block (e.g., current block) and the second block.

Prediction processing unit 304 may use the one or more lossy coding tools for the second block based on the determination that the second block is not decoded with transform skip. For instance, the operations of SDH unit 311 and DQ unit 309 may be used for the second block.

The following are one or more examples that may be utilized together or in any combination.

Clause 1: A method of decoding video data includes determining that one or more lossy coding tools are enabled at a picture level or slice level for a picture or slice of video data that includes a current block; determining that the current block is decoded with transform skip; bypassing use of the one or more lossy coding tools for the current block based on the determination that the current block is decoded with transform skip; performing a residual coding scheme to generate a residual block; and reconstructing the current block based on the residual block.

Clause 2: The method of clause 1, wherein bypassing use of the one or more lossy coding tools for the block comprises bypassing use of the one or more lossy coding tools for the block based on the determination that the block is decoded with transform skip and the determination that the one or more lossy coding tools are enabled at the picture level or slice level for the picture or slice that includes the current block.

Clause 3: The method of any of clauses 1 and 2, wherein the one or more lossy coding tools include at least one of dependent quantization or sign data hiding.

Clause 4: The method of any of clauses 1 through 3, wherein performing the residual coding scheme comprises performing transform coefficient coding (TRCC) based on the bypassing of the use of the one or more lossy coding tools.

Clause 5: The method of any of clauses 1 through 4, wherein the residual coding scheme is one of transform coefficient coding (TRCC) and transform skip residual coding (TSRC).

Clause 6: The method of any of clauses 1 through 5, wherein the current block is a first block, the method further includes determining that a second block, in the same picture or slice as the first block that is decoded with transform skip, is not decoded with transform skip; and using the one or more lossy coding tools for the second block based on the determination that the second block is not decoded with transform skip.

Clause 7: The method of clause 6, using the one or more lossy coding tools for the second block comprises using the one or more lossy coding tools for the second block based on the determination that the second block is not coded with transform skip and the determination that the one or more lossy coding tools are enabled at the picture level or slice level for the picture or slice that includes the first block and the second block.

Clause 8: A device for decoding video data includes memory configured to store the video data; and processing circuitry coupled to the memory and configured to: determine that one or more lossy coding tools are enabled at a picture level or slice level for a picture or slice of the video data that includes a current block; determine that the current block is decoded with transform skip; bypass use of the one or more lossy coding tools for the current block based on the determination that the current block is decoded with transform skip; perform a residual coding scheme to generate a residual block; and reconstruct the current block based on the residual block.

Clause 9: The device of clause 8, wherein to bypass use of the one or more lossy coding tools for the block, the processing circuitry is configured to bypass use of the one or more lossy coding tools for the block based on the determination that the block is decoded with transform skip and the determination that the one or more lossy coding tools are enabled at the picture level or slice level for the picture or slice that includes the current block.

Clause 10: The device of any of clauses 8 and 9, wherein the one or more lossy coding tools include at least one of dependent quantization or sign data hiding.

Clause 11: The device of any of clauses 8 through 10, wherein to perform the residual coding scheme, the processing circuitry is configured to perform transform coefficient coding (TRCC) based on the bypassing of the use of the one or more lossy coding tools.

Clause 12: The device of any of clauses 8 through 11, wherein the residual coding scheme is one of transform coefficient coding (TRCC) and transform skip residual coding (TSRC).

Clause 13: The device of any of clauses 8 through 12, wherein the current block is a first block, and wherein the processing circuitry is configured to: determine that a second block, in the same picture or slice as the first block that is decoded with transform skip, is not decoded with transform skip; and use the one or more lossy coding tools for the second block based on the determination that the second block is not decoded with transform skip.

Clause 14: The device of clause 13, wherein to use the one or more lossy coding tools for the second block, the processing circuitry is configured to use the one or more lossy coding tools for the second block based on the determination that the second block is not coded with transform skip and the determination that the one or more lossy coding tools are enabled at the picture level or slice level for the picture or slice that includes the first block and the second block.

Clause 16: The device of any of clauses 8 through 14, wherein the device comprises one or more of a camera, a computer, a mobile device, a broadcast receiver device, or a set-top box.

Clause 17: A device for decoding video data includes means for determining that one or more lossy coding tools are enabled at a picture level or slice level for a picture or slice of video data that includes a current block; means for determining that the current block is decoded with transform skip; means for bypassing use of the one or more lossy coding tools for the current block based on the determination that the current block is decoded with transform skip; means for performing a residual coding scheme to generate a residual block; and means for reconstructing the current block based on the residual block.

Clause 18: The device of clause 17, wherein the one or more lossy coding tools include at least one of dependent quantization or sign data hiding, and wherein the residual coding scheme is one of transform coefficient coding (TRCC) and transform skip residual coding (TSRC).

Clause 19: A computer-readable storage medium having stored thereon instructions that, when executed, cause one or more processors to: determine that one or more lossy coding tools are enabled at a picture level or slice level for a picture or slice of video data that includes a current block; determine that the current block is decoded with transform skip; bypass use of the one or more lossy coding tools for the current block based on the determination that the current block is decoded with transform skip; perform a residual coding scheme to generate a residual block; and reconstruct the current block based on the residual block.

Clause 20: The computer-readable storage medium of clause 19, wherein the one or more lossy coding tools include at least one of dependent quantization or sign data hiding, and wherein the residual coding scheme is one of transform coefficient coding (TRCC) and transform skip residual coding (TSRC).

Clause 21: A method of coding video data, the method comprising determining that one or more lossy coding tools are enabled at a picture level or slice level for a picture or slice that includes a block, determining that the block is coded with transform skip, bypassing use of the one or more lossy coding tools for the block based on the determination that the block is coded with transform skip, and performing a residual coding scheme based on the bypassing.

Clause 22: The method of clause 21, wherein bypassing use of the one or more lossy coding tools for the block comprises bypassing use of the one or more lossy coding tools for the block based on the determination that the block is coded with transform skip and the determination that the one or more lossy coding tools are enabled at the picture level or slice level for the picture or slice that includes the block and

Clause 23: The method of any of clauses 21 and 22, wherein the one or more lossy coding tools include at least one of dependent quantization or sign data hiding.

Clause 24: The method of any of clauses 21-23, wherein performing the residual coding scheme comprises performing transform coefficient coding (TRCC).

Clause 25: The method of any of clauses 21-24, wherein the residual coding scheme is one of transform coefficient coding (TRCC) and transform skip residual coding (TSRC).

Clause 26: The method of any of clauses 21-25, wherein the block is a first block, the method further comprising determining that a second block, in the same picture or slice as the first block that is coded with transform skip, is not coded with transform skip, and using the one or more lossy coding tools for the second block based on the determination that the second block is not coded with transform skip.

Clause 27: The method of clause 26, using the one or more lossy coding tools for the second block comprises using the one or more lossy coding tools for the second block based on the determination that the second block is not coded with transform skip and the determination that the one or more lossy coding tools are enabled at the picture level or slice level for the picture or slice that includes the first block and the second block.

Clause 28: The method of any of clauses 21-27, wherein performing the residual coding scheme comprises performing the residual coding scheme as part of video encoding the video data.

Clause 29: The method of any of clauses 21-27, wherein performing the residual coding scheme comprises performing the residual coding scheme as part of video decoding the video data.

Clause 30: A device for coding video data, the device comprising: memory configured to store the video data and processing circuitry coupled to the memory and configured to perform the techniques any one or more of clauses 21-29.

Clause 31: The device of clause 30, further comprising a display configured to display decoded video data.

Clause 32: The device of any of clauses 30 and 31, wherein the device comprises one or more of a camera, a computer, a mobile device, a broadcast receiver device, or a set-top box.

Clause 33: The device of any of clauses 30-32, wherein the device comprises a video decoder.

Clause 34: The device of any of clauses 30-32, wherein the device comprises a video encoder.

Clause 35: A device for coding video data, the device comprising one or more means for performing the method of any of clauses 21-29.

Clause 36: A computer-readable storage medium having stored thereon instructions that, when executed, cause one or more processors to perform the method of any of clauses 21-29.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining that one or more lossy coding tools are enabled at a picture level or slice level for a picture or slice of video data that includes a current block;
determining that the current block is decoded with transform skip;
bypassing use of the one or more lossy coding tools for the current block based on the determination that the current block is decoded with transform skip;
performing a residual coding scheme to generate a residual block; and
reconstructing the current block based on the residual block.

2. The method of claim 1, wherein bypassing use of the one or more lossy coding tools for the block comprises bypassing use of the one or more lossy coding tools for the block based on the determination that the block is decoded with transform skip and the determination that the one or more lossy coding tools are enabled at the picture level or slice level for the picture or slice that includes the current block.

3. The method of claim 1, wherein the one or more lossy coding tools include at least one of dependent quantization or sign data hiding.

4. The method of claim 1, wherein performing the residual coding scheme comprises performing transform coefficient coding (TRCC) based on the bypassing of the use of the one or more lossy coding tools.

5. The method of claim 1, wherein the residual coding scheme is one of transform coefficient coding (TRCC) and transform skip residual coding (TSRC).

6. The method of claim 1, wherein the current block is a first block, the method further comprising:
determining that a second block, in the same picture or slice as the first block that is decoded with transform skip, is not decoded with transform skip; and
using the one or more lossy coding tools for the second block based on the determination that the second block is not decoded with transform skip.

7. The method of claim 6, using the one or more lossy coding tools for the second block comprises using the one or more lossy coding tools for the second block based on the determination that the second block is not coded with transform skip and the determination that the one or more lossy coding tools are enabled at the picture level or slice level for the picture or slice that includes the first block and the second block.

8. A device for decoding video data, the device comprising:
memory configured to store the video data; and
processing circuitry coupled to the memory and configured to:
determine that one or more lossy coding tools are enabled at a picture level or slice level for a picture or slice of the video data that includes a current block;
determine that the current block is decoded with transform skip;
bypass use of the one or more lossy coding tools for the current block based on the determination that the current block is decoded with transform skip;
perform a residual coding scheme to generate a residual block; and
reconstruct the current block based on the residual block.

9. The device of claim 8, wherein to bypass use of the one or more lossy coding tools for the block, the processing circuitry is configured to bypass use of the one or more lossy coding tools for the block based on the determination that the block is decoded with transform skip and the determination that the one or more lossy coding tools are enabled at the picture level or slice level for the picture or slice that includes the current block.

10. The device of claim 8, wherein the one or more lossy coding tools include at least one of dependent quantization or sign data hiding.

11. The device of claim 8, wherein to perform the residual coding scheme, the processing circuitry is configured to perform transform coefficient coding (TRCC) based on the bypassing of the use of the one or more lossy coding tools.

12. The device of claim 8, wherein the residual coding scheme is one of transform coefficient coding (TRCC) and transform skip residual coding (TSRC).

13. The device of claim 8, wherein the current block is a first block, and wherein the processing circuitry is configured to:
determine that a second block, in the same picture or slice as the first block that is decoded with transform skip, is not decoded with transform skip; and
use the one or more lossy coding tools for the second block based on the determination that the second block is not decoded with transform skip.

14. The device of claim 13, wherein to use the one or more lossy coding tools for the second block, the processing circuitry is configured to use the one or more lossy coding tools for the second block based on the determination that the second block is not coded with transform skip and the determination that the one or more lossy coding tools are enabled at the picture level or slice level for the picture or slice that includes the first block and the second block.

15. The device of claim 8, further comprising a display configured to display reconstructed current block.

16. The device of claim 8, wherein the device comprises one or more of a camera, a computer, a mobile device, a broadcast receiver device, or a set-top box.

17. A device for decoding video data, the device comprising:
means for determining that one or more lossy coding tools are enabled at a picture level or slice level for a picture or slice of video data that includes a current block;
means for determining that the current block is decoded with transform skip;
means for bypassing use of the one or more lossy coding tools for the current block based on the determination that the current block is decoded with transform skip;
means for performing a residual coding scheme to generate a residual block; and
means for reconstructing the current block based on the residual block.

18. The device of claim 17, wherein the one or more lossy coding tools include at least one of dependent quantization or sign data hiding, and wherein the residual coding scheme is one of transform coefficient coding (TRCC) and transform skip residual coding (TSRC).

19. A computer-readable storage medium having stored thereon instructions that, when executed, cause one or more processors to:
determine that one or more lossy coding tools are enabled at a picture level or slice level for a picture or slice of video data that includes a current block;
determine that the current block is decoded with transform skip;
bypass use of the one or more lossy coding tools for the current block based on the determination that the current block is decoded with transform skip;
perform a residual coding scheme to generate a residual block; and
reconstruct the current block based on the residual block.

20. The computer-readable storage medium of claim 19, wherein the one or more lossy coding tools include at least one of dependent quantization or sign data hiding, and wherein the residual coding scheme is one of transform coefficient coding (TRCC) and transform skip residual coding (TSRC).
